(19) United States
(12) Patent Application Publication
(10) Pub. No.: US 2023/0292369 A1
(43) Pub. Date: Sep. 14, 2023

(54) METHOD AND APPARATUS FOR REPORTING AI NETWORK MODEL SUPPORT CAPABILITY, METHOD AND APPARATUS FOR RECEIVING AI NETWORK MODEL SUPPORT CAPABILITY, AND STORAGE MEDIUM, USER EQUIPMENT AND BASE STATION

(71) Applicant: SPREADTRUM SEMICONDUCTOR (NANJING) CO., LTD., Nanjing, Jiangsu (CN)

(72) Inventor: Zhenzhu LEI, Shanghai (CN)

(21) Appl. No.: 18/019,537

(22) PCT Filed: Aug. 4, 2021
(86) PCT No.: PCT/CN2021/110478

§ 371 Date: Feb. 3, 2023

(30) Foreign Application Priority Data
Aug. 5, 2020 (CN) 202010780069.6

(51) Int. Cl. H04W 74/08; H04W 74/00; H04L 41/16

(52) U.S. Cl. CPC H04W 74/0833; H04W 74/004; H04W 74/006; H04L 41/16

(57) ABSTRACT

A method and apparatus for reporting AI network model support capability, a method and apparatus for receiving AI network model support capability, a storage medium, a user equipment and a base station are provided. The method for reporting the AI network model support capability includes: determining capability of supporting an AI network model, wherein the capability of supporting the AI network model includes whether to support using the AI network model for channel estimation; and reporting the capability of supporting the AI network model using an uplink resource in a random access procedure, or triggering reporting of the capability of supporting the AI network model in a connected state.

### CROSS-REFERENCE TO RELATED APPLICATIONS

This is the U.S. national stage of application No. PCT/CN2021/110478, filed Aug. 4, 2021. Priority under 35 U.S.C. § 119(a) and 35 U.S.C. § 365(b) is claimed from Chinese Application No. 202010780069.6 filed Aug. 5, 2020, the disclosure of which is also incorporated herein by reference.

### TECHNICAL FIELD

The present disclosure generally relates to communication technology field, and more particularly, to a method and apparatus for reporting Artificial Intelligence (AI) network model support capability, a method and apparatus for receiving AI network model support capability, a storage medium, a User Equipment (UE) and a base station.

### BACKGROUND

An AI algorithm may be applied in channel estimation, where a process of estimating all channel values from a pilot is equated to a traditional image restoration/denoising process, and a deep learning algorithm for image restoration/denoising is adopted to complete the channel estimation.

Currently, channel estimation based on AI network models is done at a UE. The UE can learn performance of each AI network model configured and a size of input and output.

### SUMMARY

Embodiments of the present disclosure enable a base station to learn relevant parameters of an AI network model at the UE.

In an embodiment of the present disclosure, a method for reporting AI network model support capability is provided, including: determining capability of supporting an AI network model, wherein the capability of supporting the AI network model includes whether to support using the AI network model for channel estimation; and reporting the capability of supporting the AI network model using an uplink resource in a random access procedure, or triggering reporting of the capability of supporting the A network model in a connected state.

In an embodiment of the present disclosure, a storage medium having computer instructions stored therein is provided, wherein when the computer instructions are executed, the method for reporting the AI network model support capability or the method for receiving the AI network model support capability is performed.

In an embodiment of the present disclosure, a UE including a memory and a processor is provided, wherein the memory has computer instructions stored therein, and when the processor executes the computer instructions, the method for reporting the AI network model support capability is performed.

### BRIEF DESCRIPTION OF THE DRAWINGS

FIG. 1 is a flow chart of a method for reporting AI network model support capability according to an embodiment.

FIG. 2 is a diagram of an application scenario according to an embodiment.

FIG. 3 is a diagram of an application scenario according to an embodiment.

FIG. 4 is a flow chart of a method for receiving AI network model support capability according to an embodiment.

FIG. 5 is a structural diagram of an apparatus for reporting AI network model support capability according to an embodiment.

FIG. 6 is a structural diagram of an apparatus for receiving AI network model support capability according to an embodiment.

### DETAILED DESCRIPTION

As described in the background, how a base station learns relevant parameters of an AI network model at a UE is an urgent technical problem to be solved.

Inventors found based on research that if a UE supports AI-based channel estimation, a demand for demodulation reference signal density is relatively low. That is, compared with a UE using traditional channel estimation, a network side may configure a lower-density Demodulation Reference Signal (DMRS) for the UE that supports AI-based channel estimation.

In embodiments of the present disclosure, a UE is capable of reporting capability of supporting an AI network model in a random access procedure, so that a base station can configure a demodulation reference signal for the UE based on the UE's capability of supporting the AI network model, thereby realizing optimal assignment of resources.

In the embodiments of the present disclosure, the UE can indirectly indicate its capability of supporting the AI network model via a type of a subset of ROs used for initiating random access, without occupying additional resources or signaling to report the capability, thereby saving resources and signaling overhead.

In order to clarify the objects, characteristics and advantages of the disclosure, embodiments of present disclosure will be described in detail in conjunction with accompanying drawings.

Referring to FIG. 1, FIG. 1 is a flow chart of a method for reporting AI network model support capability according to an embodiment.

The method as shown in FIG. 1 may be applied to a UE and include S101 and S102.

In S101, the UE determines capability of supporting an AI network model, wherein the capability of supporting the AI network model includes whether to support using the AI network model for channel estimation.

In S102, the UE reports the capability of supporting the AI network model using an uplink resource in a random access procedure, or triggers reporting of the capability of supporting the AI network model in a connected state.

It should be noted that sequence numbers of steps in the embodiment do not limit an execution order of the steps.

It could be understood that, in some embodiments, the method may be implemented by software programs running in a processor integrated in a chip or a chip module.

In some embodiments, the AI network model performs channel estimation according to an input channel estimation matrix, and may be any appropriate AI network model, such as a model obtained by training based on historical data. The AI network model may include one AI network model or a plurality of AI network models.

In some embodiments, in S101, if the UE is configured with an AI network model, it means that the UE has the capability of supporting the AI network model, that is, the UE supports using the AI network model for channel estimation; or if the UE is not configured with an AI network model, it means that the UE does not have the capability of supporting the AI network model.

To enable the base station to know the UE's capability of supporting the AI network model, in some embodiments, in S102, the UE may use an uplink resource to report the capability of supporting the AI network model during the random access procedure, or trigger reporting of the capability of supporting the AI network model in a connected state. That is, the base station actively reports during the random access procedure, while it is triggered to report in the connected state, where a specific triggering way may be signaling indication or event triggering.

In some embodiments, the UE may transmit messages to a network through the uplink resource configured by the base station during the random access procedure, such as message 1 (Msg1) or message 3 (Msg3). Then, the UE can reuse the uplink resource to report the capability of supporting the AI network model, so as to complete the reporting of the capability of the AI network model while completing the random access.

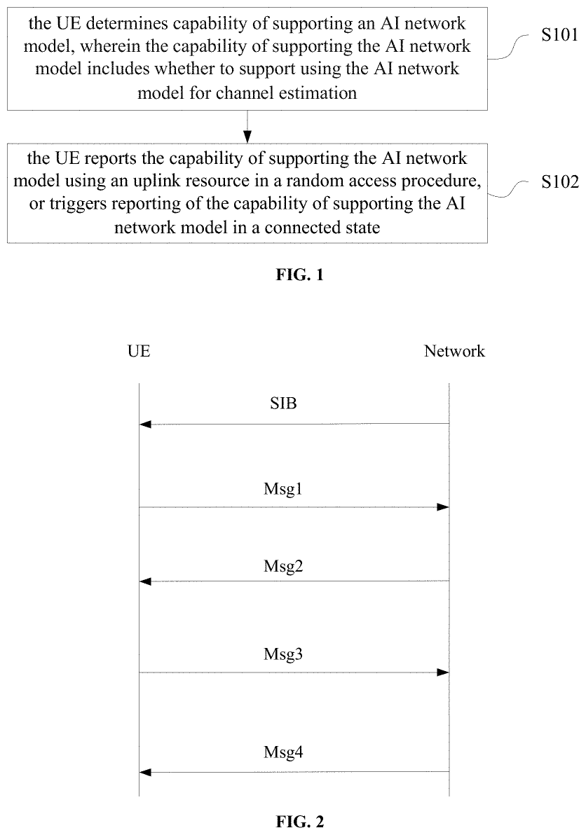

Referring to FIG. 2, in the random access procedure, the network transmits a System Information Block (SIB), and SIB1 indicates a resource for transmitting a preamble (Msg1). By reading the SIB1, the UE determines the resource for transmitting the preamble to the network to indicate its intention to access the network. If the network receives Msg1 correctly, the network transmits a random access response message (Msg2) scrambled with a Random Radio Network Temporary Identity (RA-RNTI) to the UE. After transmitting Msg1, the UE may use RA-RNTI to monitor Msg2 from the network to descramble Msg2. Msg2 may include indication of a resource used for the UE transmitting Mgs3. Afterward, the UE transmits its identity and initial access establishment request (Msg3) to the network through uplink scheduling instruction in Msg2. Finally, the network may notify the UE of the completion of the initial access procedure through Msg4.

That is, the UE may report the capability of supporting the AI network model through Msg1 or Mgs3.

In the embodiments of the present disclosure, the UE is capable of reporting the capability of supporting the AI network model in the random access procedure, so that the base station can configure a demodulation reference signal for the UE based on the UE's capability of supporting the AI network model, thereby realizing optimal assignment of resources.

In some embodiments, S102 may include: reporting the capability of supporting the AI network model using a time-frequency resource for transmitting a preamble.

As described above, the UE may transmit the preamble through the resource configured by the base station for transmitting the preamble and may also report the capability of supporting the AI network model, so that the base station can learn the UE's capability of supporting the AI network model while receiving the preamble.

Still referring to FIG. 2, after receiving the SIB1 from the network, the UE learns the resource for transmitting Msg1, and transmits Msg1 along with the capability of supporting the AI network model at a position of the resource for transmitting Msg1.

Further, the above-mentioned step may specifically include: determining subsets of ROs and types of the subsets, wherein the types of the subsets include being used for initiating random access by a UE that supports the AI network model and being used for initiating random access by a UE that does not support the AI network model; and determining a to-be-used subset of the ROs based on the capability of supporting the AI network model and the types of the subsets, and initiating random access using any RO in the to-be-used subset of the ROs.

In some embodiments, the UE can acquire relevant configuration of the ROs through the SIB1 message. The relevant configuration specifically includes a cycle of the ROs, the number of ROs in a time domain in each PRACH cycle, the number of ROs multiplexed in frequency, and the like. RO refers to a time-frequency domain resource used for transmitting a preamble.

In some embodiments, the UE may determine the subsets of ROs and the types of the subsets through the SIB1 message. The subsets of the ROs and the types may be pre-configured by the base station. Different subsets of ROs occupy different frequency and/or time domain resources.

In some embodiments, the UE may receive the subset of ROs and the types of the subsets configured by the base station. The base station may carry the configured subsets of ROs and types in SIB1.

In the embodiments of the present disclosure, the UE can indirectly indicate its capability of supporting the AI network model via the type of the subset of ROs used for initiating random access, without occupying additional resources or signaling to report the capability, thereby saving resources and signaling overhead.

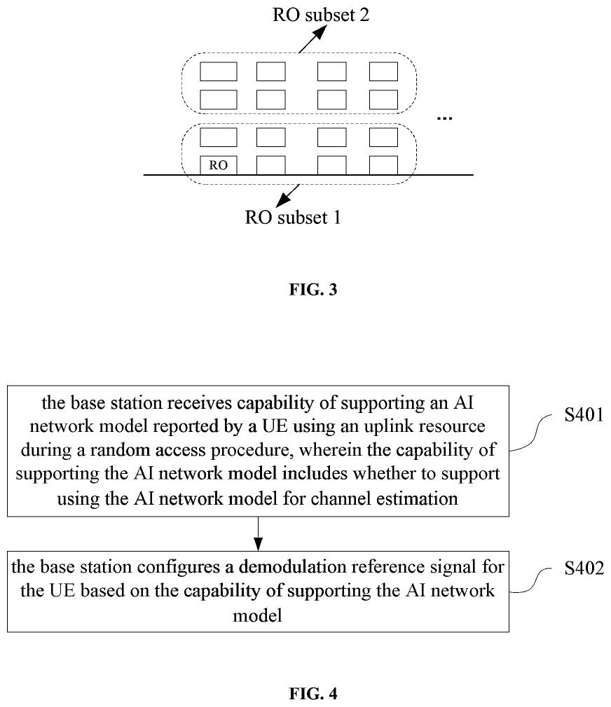

Referring to FIG. 3, the network evenly divides the ROs into two subsets (i.e., RO subset 1 and RO subset 2) in frequency. The RO subset 2 is configured to be used for UEs that support AI channel estimation to initiate random access, and the RO subset 1 is configured for UEs that do not support AI channel estimation to initiate random access. If the UE selects an RO in the RO subset 2 to initiate random access, that is, selects the RO in the RO subset 2 to transmit Msg1, the network considers that the UE supports AI channel estimation. Otherwise, if the UE selects an RO in the RO subset 1 to initiate random access, the network considers that the UE does not support AI channel estimation.

In some embodiments, the UE may use a specific preamble to report the capability of supporting the AI network model.

When transmitting Msg1, the UE may select a preamble from 64 different preambles. In some embodiments, the base station may divide the preambles into different types of preamble subsets in advance, for example, two types of preamble subsets. One type of preamble subset is used by UEs that support AI estimation, and the other type of preamble subset is used by UEs that do not support AI estimation. In other words, the UE can indirectly inform the base station whether the UE supports the AI network model by using different types of preamble subsets.

It could be understood that the number of preambles in the preamble subset may be set flexibly, which is not limited in the embodiments of the present disclosure.

Further, the preamble subset and its type may be pre-configured by the base station and transmitted to the UE.

In some embodiments, S102 may include: reporting the capability of supporting the AI network model using Msg 3.

Different from the foregoing embodiments, in the embodiments, after receiving Msg2 from the network, the UE learns the resource for transmitting Msg3, and transmits Msg3 along with the capability of supporting the AI network model at a position of the resource for transmitting Msg3.

In the embodiments of the present disclosure, by reusing message 3, the capability of supporting the AI network model can be reported while a random access request is initiated, thereby saving resources and signaling overhead.

In some embodiments, S102 may include: receiving a support capability reporting trigger instruction from a base station, wherein the support capability reporting trigger instruction indicates to report the capability of supporting the AI network model; and reporting the capability of supporting the AI network model using a PDSCH scheduled by a PDCCH in response to the support capability reporting trigger instruction.

Different from the foregoing embodiments in which the UE actively reports its capability of supporting the AI network model, in the embodiments, the base station transmits a support capability reporting trigger instruction to the UE, and in response to the support capability reporting trigger instruction, the UE uses the PDSCH scheduled by the PDCCH to report its capability of supporting the AI network model. That is, the UE reports the capability of supporting the AI network model merely in response to the instruction from the base station.

In some embodiments, the base station instructing the UE to report through the trigger instruction may refer to instructing the UE to report by carrying the trigger instruction in a Media Access Control (MAC) Control Element (CE).

In some embodiments, the above steps may include: detecting a support capability reporting trigger event, wherein the support capability reporting trigger event includes a bandwidth part switching event; and reporting the capability of supporting the AI network model on bandwidth part after switching in response to the support capability reporting trigger event being detected.

Different from the foregoing embodiments in which the UE reports the capability of supporting the AI network model merely in response to the instruction from the base station, in the embodiments, the UE reports its capability of supporting the AI network model in response to event triggering. Specifically, the UE detects a BandWidth Part (BWP) switching event. If the support capability reporting trigger event is detected, such as switching from BWP1 to BWP2, the UE uses BWP after switching to report the capability of supporting AI network model. Otherwise, the UE does not report its capability of supporting the AI network model.

In some embodiments, the network instructs the UE to switch the BWP through Downlink Control Information (DCI), that is, the DCI carries a specific bit to instruct the UE to switch the BWP. After receiving the BWP switching instruction, the UE switches the BWP, and reports the capability of supporting the AI network model through the PDSCH resource scheduled by the PDCCH on the new BWP after switching.

By using the triggering instruction to indicate reporting or using event triggering for reporting, the UE does not need to report when it does not have the capability of supporting the AI network model, thereby saving resource overhead.

In some embodiments, after S102, the method may further include: if the capability of supporting the AI network model indicates supporting using the AI network model for channel estimation, triggering reporting an input size of all the AI network model.

In some embodiments, after the UE reports to the base station that it has the capability to support the AI network model, the base station can instruct the UE to report the input size of the AI network model through a trigger instruction, and at the same time assign an uplink resource for the UE to report the input size of the AI network model. The UE can report the input size of all the AI network model on the uplink resource configured by the base station. In other words, the UE may support a plurality of AI network models, and as different AI network models have different input/output sizes, the UE can notify the network of the input/output sizes of all AI network models it supports.

That is, the UE may report the input/output sizes of the AI models to the network through Msg1 or Msg3. The UE may report the input/output size of all the AI network model to the network through the PDSCH scheduled by the PDCCH.

Referring to FIG. 4, FIG. 4 is a flow chart of a method for receiving AI network model support capability according to an embodiment. The method as shown in FIG. 1 may be applied to a network side, such as a base station, and include S401 and S402.

In S401, the base station receives capability of supporting an AI network model reported by a UE using an uplink resource during a random access procedure, wherein the capability of supporting the AI network model includes whether to support using the AI network model for channel estimation.

In S402, the base station configures a demodulation reference signal for the UE based on the capability of supporting the AI network model.

In some embodiments, the base station may obtain each UE's capability of supporting the AI network model during the random access procedure, so as to configure a Demodulation Reference Signal (DMRS) for the UE according to the corresponding capability.

It could be understood that, in some embodiments, the method may be implemented by software programs running in a processor integrated in a chip or a chip module.

Further, S402 as shown in FIG. 4 may include: configuring the demodulation reference signal with a particular density for the UE, wherein the particular density is determined based on whether the UE supports using the AI network model for channel estimation, and the density of the demodulation reference signal configured in response to the UE supporting using the AI network model for channel estimation is lower than the density of the demodulation reference signal configured in response to the UE not supporting using the AI network model for channel estimation. That is, for the UE supporting using the AI network model for channel estimation, the base station configures a DMRS with a relatively low density for it, and for the UE not supporting using the AI network model for channel estimation, the base station configures a DMRS with a relatively high density for it.

In short, UEs that support AI network models may be configured with lower-density DMRS, thereby saving resource overhead on the network side.

In some embodiments, before S201, the method may further include: transmitting to the UE subsets of ROs and types of the subsets, wherein the types of the subsets include being used for initiating random access by a UE that supports the AI network model and being used for initiating random access by a UE that does not support the AI network model.

In the embodiments, the base station may transmit the subsets of ROs and types of the subsets to the UE in SIB1, and different types of subsets have different functions. The UE may indirectly indicate to the base station its capability of supporting the AI network model by transmitting preambles using different types of subsets of ROs. Accordingly, the base station can determine the capability of supporting the AI network model for the UE that transmits the preamble based on the type of the subset used by the received preamble.

In some embodiments, before S201, the method may further include: transmitting a support capability reporting trigger instruction to the UE, wherein the support capability reporting trigger instruction indicates the UE to report the capability of supporting the AI network model.

Different from the foregoing embodiments in which the base station determines the capability of supporting the AI network model for the UE that transmits the preamble based on the type of the subset of ROs used by the received preamble, in the embodiments, the UE reports its capability of supporting the AI network model in response to the support capability report triggering instruction, so that the base station can directly obtain the UE's capability of supporting the AI network model. For example, the UE's capability of supporting the AI network model is obtained directly through a bit value in Msg3.

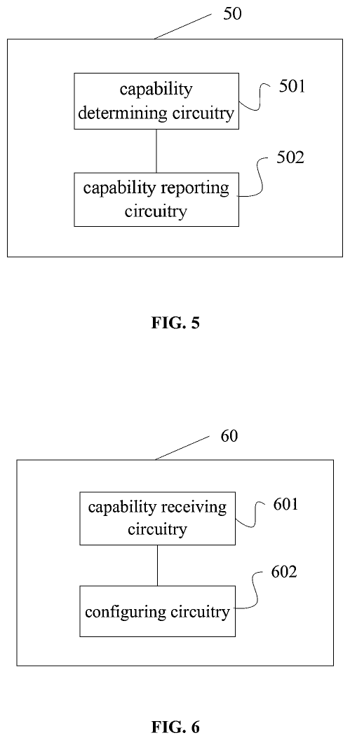

Referring to FIG. 5, FIG. 5 is a structural diagram of an apparatus for reporting AI network model support capability according to an embodiment. The apparatus 50 includes a capability determining circuitry 501 and a capability reporting circuitry 502.

The capability determining circuitry 501 is configured to determine capability of supporting an AI network model, wherein the capability of supporting the AI network model includes whether to support using the AI network model for channel estimation. The capability reporting circuitry 502 is configured to report the capability of supporting the AI network model using an uplink resource in a random access procedure.

Referring to FIG. 6, FIG. 6 is a structural diagram of an apparatus for receiving AI network model support capability according to an embodiment. The apparatus 60 includes a capability receiving circuitry 601 and a configuring circuitry 602.

The capability receiving circuitry 601 is configured to receive capability of supporting an AI network model reported by a UE using an uplink resource during a random access procedure, wherein the capability of supporting the AI network model includes whether to support using the AI network model for channel estimation. The configuring circuitry 602 is configured to configure a demodulation reference signal for the UE based on the capability of supporting the AI network model.

In the embodiments of the present disclosure, the UE is capable of reporting the capability of supporting the AI network model in the random access procedure, so that the base station can configure a demodulation reference signal for the UE based on the UE's capability of supporting the AI network model, thereby realizing optimal assignment of resources.

Working principles and modes of the apparatus 50 for reporting the AI network model support capability and the apparatus 60 for receiving the AI network model support capability may be referred to the above descriptions of FIG. 1 to FIG. 4 and are not described in detail here.

In some embodiments, each module/unit of each apparatus and product described in the above embodiments may be a software module/unit or a hardware module/unit or may be a software module/unit in part, and a hardware module/unit in part. For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a storage medium having computer instructions stored therein is provided, wherein when the computer instructions are executed, the above method as shown in FIG. 1 or FIG. 4 is performed. In some embodiments, the storage medium may be a computer readable storage medium and may include a non-volatile or a non-transitory memory, or include a ROM, a RAM, a magnetic disk or an optical disk.

In an embodiment of the present disclosure, a UE including a memory and a processor is provided, wherein the memory has computer instructions stored therein, and when the processor executes the computer instructions, the above method as shown in FIG. 1 is performed. The UE may include but is not limited to a terminal device, such as a mobile phone, a computer or a tablet computer.

In an embodiment of the present disclosure, a base station including a memory and a processor is provided, wherein the memory has computer instructions stored therein, and when the processor executes the computer instructions, the above method as shown in FIG. 4 is performed.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

1. A method for reporting Artificial Intelligence (AI) network model support capability, comprising:
determining capability of supporting an AI network model, wherein the capability of supporting the AI network model comprises whether to support using the AI network model for channel estimation; and
reporting the capability of supporting the AI network model using an uplink resource in a random access procedure or triggering reporting of the capability of supporting the AI network model in a connected state.

2. The method according to claim 1, wherein said reporting the capability of supporting the AI network model using an uplink resource in a random access procedure comprises:
reporting the capability of supporting the AI network model using a time-frequency resource for transmitting a preamble.

3. The method according to claim 2, wherein said reporting the capability of supporting the AI network model using a time-frequency resource for transmitting a preamble comprises:
determining subsets of Physical Random Access Channel Occasions (ROs) and types of the subsets, wherein the types of the subsets comprise being used for initiating random access by a User Equipment (UE) that supports the AI network model and being used for initiating random access by a UE that does not support the AI network model; and
determining a to-be-used subset of the ROs based on the capability of supporting the AI network model and the types of the subsets and initiating random access using any RO in the to-be-used subset of the ROs.

4. The method according to claim 3, wherein prior to determining the subsets of ROs and the types of the subsets, the method further comprises:
receiving the subsets of ROs and the types of the subsets which are configured by a base station.

5. The method according to claim 2, wherein said reporting the capability of supporting the AI network model using a time-frequency resource for transmitting a preamble comprises:
determining subsets of preambles and types of the subsets, wherein the types of the subsets comprise being used for initiating random access by a UE that supports the AI network model and being used for initiating random access by a UE that does not support the AI network model; and
determining a to-be-used subset of the preambles based on the capability of supporting the AI network model and the types of the subsets and reporting the capability of supporting the AI network model using a preamble in the to-be-used subset of the preambles.

6. The method according to claim 1, wherein said reporting the capability of supporting the A network model using an uplink resource in a random access procedure comprises:
reporting the capability of supporting the AI network model using message 3.

7. The method according to claim 1, wherein said triggering reporting of the capability of supporting the AI network model in a connected state comprises:
receiving a support capability reporting trigger instruction from a base station, wherein the support capability reporting trigger instruction indicates to report the capability of supporting the AI network model; and
reporting the capability of supporting the AI network model using a Physical Downlink Shared Channel (PDSCH) scheduled by a Physical Downlink Control Channel (PDCCH) in response to the support capability reporting trigger instruction.

8. The method according to claim 1, wherein said triggering reporting of the capability of supporting the AI network model in a connected state comprises:
detecting a support capability reporting trigger event, wherein the support capability reporting trigger event comprises a bandwidth part switching event; and
reporting the capability of supporting the AI network model on bandwidth part after switching using a Physical Downlink Shared Channel (PDSCH) scheduled by a Physical Downlink Control Channel (PDCCH) in response to the support capability reporting trigger event being detected.

9. The method according to claim 7, further comprising:
based on that the capability of supporting the AI network model indicates supporting using the AI network model for channel estimation, reporting an input size of all the AI network model along with the capability of supporting the AI network model.

10. The method according to claim 1, wherein following reporting the capability of supporting the AI network model using the uplink resource in the random access procedure, the method further comprises:
based on that the capability of supporting the AI network model indicates supporting using the AI network model for channel estimation, receiving an AI model size reporting trigger instruction from a base station, wherein the support capability reporting trigger instruction indicates to report an input size of all the AI network model; and
reporting the input size of all the AI network model using a PDSCH scheduled by a PDCCH in response to the AI model size reporting trigger instruction.

11. (canceled)

12. (canceled)

13. (canceled)

14. (canceled)

15. (canceled)

16. (canceled)

17. (canceled)

18. A non-transitory storage medium storing one or more programs, the one or more programs comprising computer instructions, which, when executed by a processor, cause the processor to:
determine capability of supporting an AI network model, wherein the capability of supporting the AI network model comprises whether to support using the AI network model for channel estimation; and
report the capability of supporting the AI network model using an uplink resource in a random access procedure, or trigger reporting of the capability of supporting the AI network model in a connected state.

19. A User Equipment (UE) comprising a memory and a processor, wherein the memory stores one or more programs, the one or more programs comprising computer instructions, which, when executed by the processor, cause the processor to:
determine capability of supporting an AI network model, wherein the capability of supporting the AI network model comprises whether to support using the AI network model for channel estimation; and
report the capability of supporting the AI network model using an uplink resource in a random access procedure, or trigger reporting of the capability of supporting the AI network model in a connected state.

20. (canceled)

21. The method according to claim 8, further comprising:
based on that the capability of supporting the AI network model indicates supporting using the AI network model for channel estimation, reporting an input size of all the AI network model along with the capability of supporting the AI network model.

22. The UE according to claim 19, wherein the processor is further caused to:
report the capability of supporting the AI network model using a time-frequency resource for transmitting a preamble.

23. The UE according to claim 22, wherein the processor is further caused to:
determine subsets of Physical Random Access Channel Occasions (ROs) and types of the subsets, wherein the types of the subsets comprise being used for initiating random access by a User Equipment (UE) that supports the AI network model and being used for initiating random access by a IE that does not support the AI network model; and
determine a to-be-used subset of the ROs based on the capability of supporting the AI network model and the types of the subsets and initiate random access using any RO in the to-be-used subset of the ROs.

24. The UE according to claim 23, wherein the processor is further caused to:
receive the subsets of ROs and the types of the subsets which are configured by a base station.

25. The UE according to claim 22, wherein the processor is further caused to:
determine subsets of preambles and types of the subsets, wherein the types of the subsets comprise being used for initiating random access by a UE that supports the AI network model and being used for initiating random access by a UE that does not support the AI network model; and
determine a to-be-used subset of the preambles based on the capability of supporting the AI network model and the types of the subsets, and report the capability of supporting the AI network model using a preamble in the to-be-used subset of the preambles.

26. The UE according to claim 19, wherein the processor is further caused to:
report the capability of supporting the AI network model using message 3.

27. The UE according to claim 19, wherein the processor is further caused to:
receive a support capability reporting trigger instruction from a base station, wherein the support capability reporting trigger instruction indicates to report the capability of supporting the AI network model; and
report the capability of supporting the AI network model using a Physical Downlink Shared Channel (PDSCH) scheduled by a Physical Downlink Control Channel (PDCCH) in response to the support capability reporting trigger instruction.

28. The UE according to claim 19, wherein the processor is further caused to:
detect a support capability reporting trigger event, wherein the support capability reporting trigger event comprises a bandwidth part switching event; and
report the capability of supporting the AI network model on bandwidth part after switching using a Physical Downlink Shared Channel (PDSCH) scheduled by a Physical Downlink Control Channel (PDCCH) in response to the support capability reporting trigger event being detected.
